(19) United States
(12) Patent Application Publication
(10) Pub. No.: US 2006/0092440 A1
(43) Pub. Date: May 4, 2006

(54) Human visual system based design of color signal transformation in a color imaging system

(76) Inventor: Farhan A. Bagai, Fremont, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/980,132

(22) Filed: Nov. 1, 2004

(51) Int. Cl. G06F 15/00

(52) U.S. Cl. 358/1.9; 358/3.27; 358/518

(57) ABSTRACT

Simulated noise is applied to an image in a first color space, which is transformed into noisy image data in a second color space that includes a luminance and a chrominance channel. The color transformation is generated to reduce the noise in the luminance channel. In one aspect, the color transformation is incorporated into a color imaging system, and the simulated noise is representative of the noise produced by the color imaging system. In another aspect, the first color space is an RGB color space and the second color space is a YCbCr color space.

### TECHNICAL FIELD

Embodiments of the invention relate to the field of digital imaging, and more specifically to the design of color signal transformations.

### COPYRIGHT NOTICE/PERMISSION

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright® 2003, Sony Electronics, Inc., All Rights Reserved.

### BACKGROUND

Conventional digital cameras include a process to transform captured color signals from a device dependent color space (RGB, CMYG, etc) to a device independent color space (such as YCbCr) color space before the image is compressed and stored into memory. For instance, RGB describes a color model where light (e.g., filtered red, green, and blue light) is added together to create various colors. YCbCr describes color using a luminance value with two chrominance values. RGB, CMYG, and YCbCr color spaces are well known to those of ordinary skill in the art.

Traditionally, the prime motivation for the design of digital camera color transformations was color fidelity. Noise was not considered significant to merit a more dominant role in the design process of a digital camera because the signal-to-noise ratio (SNR) per pixel was high. However, over the years, as the spatial resolution of the digital camera has increased due to the increased number of pixels used to reproduce an image, the per-pixel SNR has decreased causing noise artifacts to be reproduced on the generated image.

Methodologies currently exist to reduce noise from appearing on the generated image. However, these methodologies adversely affect the sharpness, color, and brightness of the generated digital image. Consequently, noise considerations have become quite important during the design of a digital camera.

### SUMMARY

Simulated noise is applied to an image in a first color space, which is transformed into noisy image data in a second color space that includes a luminance and a chrominance channel. The color transformation is generated to reduce the noise in the luminance channel. In one aspect, the color transformation is incorporated into a color imaging system, and the simulated noise is representative of the noise produced by the color imaging system. In another aspect, the first color space is an RGB color space and the second color space is a YCbCr color space.

### BRIEF DESCRIPTION OF THE DRAWINGS

FIG. 1 illustrates one embodiment of image processing components of an image processing application.

FIG. 2 illustrates a flow diagram for one embodiment of a color transform design method.

FIG. 3 illustrates one embodiment of a color imaging system for processing an image of a scene to be stored in a digital format.

FIG. 4 illustrates one embodiment of a computer system used to create a color transformation.

### DETAILED DESCRIPTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional and other changes may be made without departing from the scope of the present invention. The following detailed description is, therefore, not to be taken in a limiting sense, and the scope of the present invention is defined only by the appended claims.

The following describes a color signal transformation methodology that enhances noise reduction without affecting color fidelity in a color imaging system. More specifically, the color signal transformation minimizes noise and color shifts in the luminance and chrominance channels of a perceptually uniform color space. In this fashion, perceptually significant noise reduction is achieved.

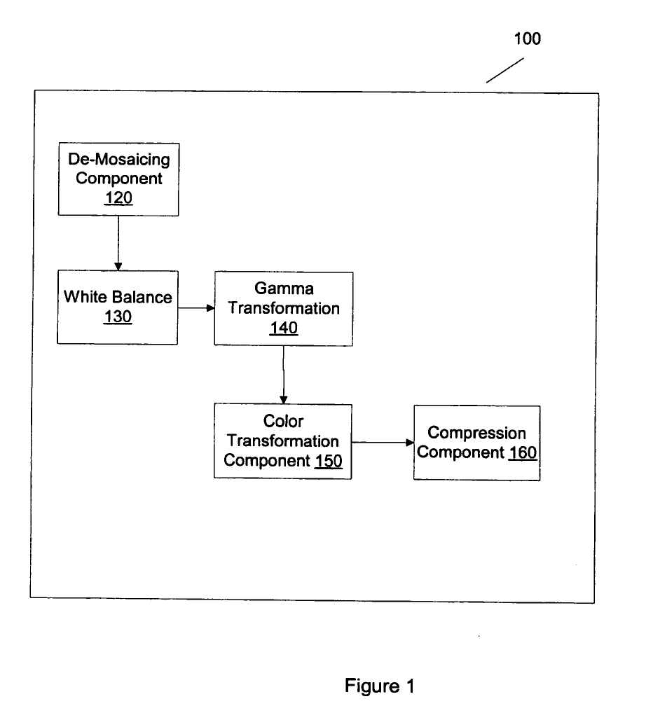

FIG. 1 illustrates one embodiment of image processing components of an image processing application 100. The image processing application 100 includes a de-mosaicing component 120, a white balance component 130, a gamma transformation component 140, a color transformation component 150, and a compression component 160.

The de-mosaicing component 120 converts a raw image of a scene into a full color image. For example, the de-mosaicing component 120 analyzes neighboring pixel color values to determine the resulting color value for a particular pixel. Thus, the de-mosaicing component 120 delivers a full resolution image that appears as if each pixel's color value was derived from a combination of, for example, the red, blue, and green primary colors.

The white balance component 130 receives the demosaic image data output from the de-mosaicing component 120 and sets the overall color tone of a digital image, correcting for different colors of illumination and for color biases inherent in the sensor. The gamma transformation component 140 receives the output image data from the white balance component 130 and tunes the image histogram, attempting to make details in both light and dark portions of the image visible. The color transformation component 150 receives the output image data from the gamma transformation component 140 and transforms the image from a first color space (e.g., RGB, YCbCr, CMYG (Cyan, Magenta, Yellow, and Green), etc.) to a second color space.

The compression component 160 receives the output image data from the gamma transformation component 140 and compresses the digital image to be saved to a data store. The compression component 160 may use well known compression algorithms such as the Joint Photographic Experts Group (JPEG) compression algorithm.

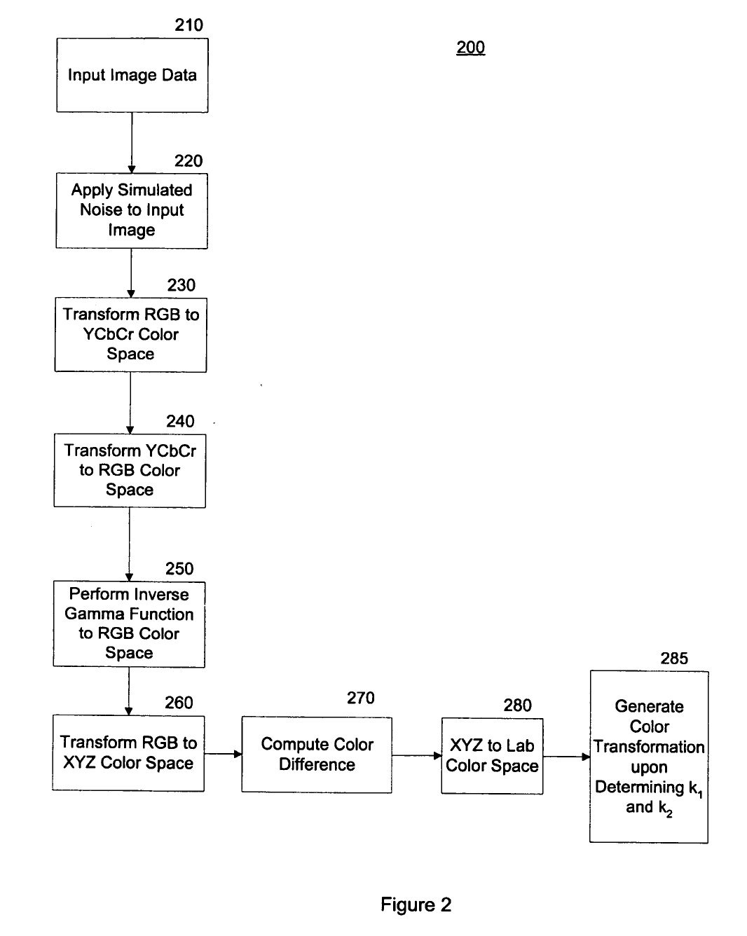

Contrast sensitivity of the human viewer to spatial variations in the chrominance channel falls off faster as a function of increasing spatial frequency than does the human response to spatial variations in luminance. This implies that the chrominance channels have a narrower visible bandwidth than the luminance channel. Thus, in one embodiment, the following in conjunction with FIG. 2, describes shifting noise to the high-frequency regions of the chromatic channels, where it is least visible. This is to mitigate the appearance of noise to the human visual system. Moreover, to minimize the color shifts that occur during imaging processing, the color transformation component 150 is designed to detect and reduce the visible noise without adversely affecting the color of the image described in the chrominance channels.

The following description describes a methodology to design a RGB to YcbCr color signal transformation that corrects color shifts in the luminance and chrominance color channels using the color transformation component 150 for a typical digital camera. Furthermore, in the following description vectors are represented by boldface lower case letters, matrices by boldface uppercase letters, super-script T denotes transpose, [m] represents discrete spatial coordinates, bar depicts raw rgb values, prime denotes non-linear rgb, hat describes an estimate, and function f_{type}[m] represents a 3-tuple discrete space image.

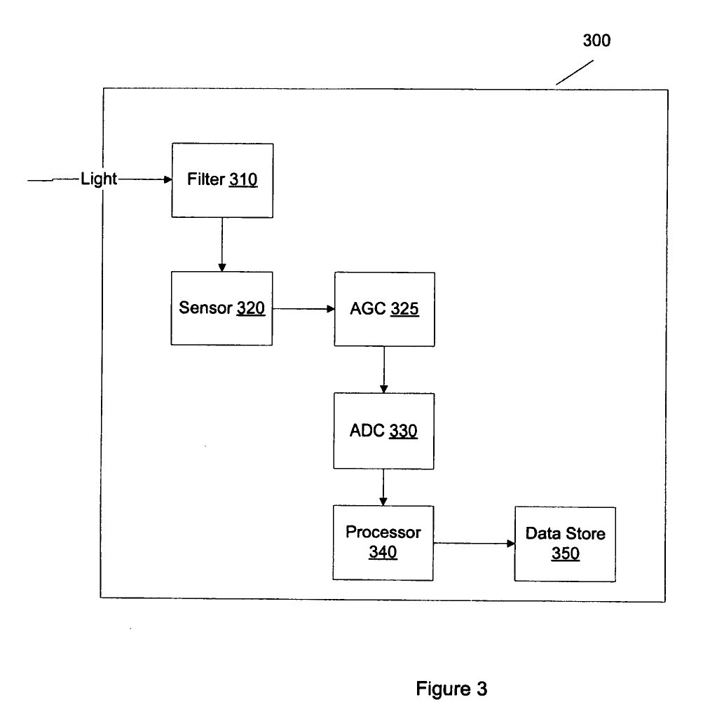

FIG. 2 illustrates one embodiment of a color transform design method 200 that executes within a processor such as described below in conjunction with FIG. 3. In one embodiment, the method 200 determines the RGB to YCbCr color transformation (K) that maximizes the best trade-off between noise reduction and color fidelity during image processing. An example of the color transformation K is written as:

$$K = [ \begin{matrix}{k}_{1} & {k}_{2} & 1 - {k}_{1} - {k}_{2} \\ - 0.299 & - 0.587 & 0.886 \\ 0.701 & - 0.587 & - 0.114\end{matrix} ] \qquad ( 1 )$$

In the first row of K, there are two independent variables k₁ and k₂. The remaining 2 rows are the same as the digital video standard recommendation 601 (Rec. 601) RGB to YCbCr transformation published by the International Telecommunication Union—radiocommunication (ITU-R) standards body. As will be described, the values of k₁ and k₂ are obtained by minimizing some measure of the noise in Lab color space that closely follows human vision.

At block 210, the method 200 receives input image data of a scene created under a specific illuminant in RGB color space. For example, the input image data is a color patch, such as a “Macbeth” 24 color patches that includes 24 true colors that are later compared with the generated digital image, as will be described in conjunction with block 270. The input image data may also be provided under various lighting conditions such as daylight, evening light, artificial light, etc.

At block 220, the method 200 applies noise data to the input image to simulate various forms of noise that might occur during imaging processing. For example, the noise applied may represent shot and thermal noise, and the noise from the de-mosaicing component 120, the white balance component 130, the gamma transformation component 140, an automatic gain controller, and/or an analog-to-digital converter for a specific imaging device. The output represents the input image in a non-linear RGB color space including the simulated noise.

At block 230, the method 200 transforms the noisy RGB image data to a YCbCr color space data. At block 240, the method 200 transforms the YCbCr color space image data to a non-linear RGB color space image data of the scene. In one embodiment, the YCbCr to RGB transformation is performed using the inverse of the standard Rec. 601 transformation.

The inverse Rec. 601 YCbCr to r′g′b transformation is given by:

$$A = {[ \begin{matrix}0.299 & 0.587 & 0.114 \\ - 0.299 & - 0.587 & 0.886 \\ 0.701 & - 0.587 & - 0.114\end{matrix} ]}^{- 1} = [ \begin{matrix}1.0 & 0 & 1.0 \\ 1.0 & - 0.1942 & - 0.5094 \\ 1.0 & 1.00 & 0\end{matrix} ] \qquad ( 2 )$$

At block 250, the method 200 applies an inverse gamma function to convert to an estimated linear RGB space. The inverse gamma function for the estimated \hat{r}ĝ\hat{b} can be written as

$$[ \begin{matrix}\hat{r} \\ \hat{g} \\ \hat{b}\end{matrix} ] = [ \begin{matrix}{\hat{r}}^{\frac{1}{γ}} \\ {\hat{g}}^{\frac{1}{γ}} \\ {\hat{b}}^{\frac{1}{γ}}\end{matrix} ] \qquad ( 3 )$$

At block 260, the method 200 transforms the estimated linear RGB color space image data of the scene to a non-linear color space. In one embodiment the non-linear color space is that specified by the International Commission of Lighting (Commission Internationale L'Eclairge) or CIE XYZ color space.

At block 270, the method 200 computes the color difference between the XYZ color space image data and a true XYZ image data without the noise. For example, the method 200 may subtract the true XYZ value from the noisy data to give the error value in XYZ color space. This error value represents the color error incurred by the inclusion of noise during the simulated image processing. The true XYZ version of the image is obtained by using the Rec. 601 standard values for the first row of K, i.e. k₁−0.0299 and k₂=0.587.

At block 280, the method 200 transforms the error value in XYZ color space to the Lab color space. In this way, noises from all sources (thermal, shot, spatial noise due to demosaicing, edge enhancement, and filtering) are propagated to the Lab color space. The image in Lab space ε_{Lab}[m] contains variations due to the presence of noise and the error incurred due to the color shift from the true value. The transformation from the XYZ color space to the Lab color space can be written as:

$$\begin{matrix}[ \begin{matrix}L * \\ a * \\ b *\end{matrix} ] = N [ \begin{matrix}f ( X ) \\ f ( Y ) \\ f ( Z )\end{matrix} ] + [ \begin{matrix}- 16 \\ 0 \\ 0\end{matrix} ] \\ where & ( 4 ) \\ N = [ \begin{matrix}0 & 116 & 0 \\ 500 & - 500 & 0 \\ 0 & 200 & - 200\end{matrix} ] & ( 5 )\end{matrix}$$

At block 285, the method 200 generates at least one color transformation (K) upon determining the values of k₁ and k₂ that minimizes visible noise without significantly altering the color. In one embodiment, the color transformation component 150 is configured to use at least one of the previously generated transformations K based on the illuminants and gain values. For example, the illuminant value represents the brightness of the lighting conditions used in the original scene. The gain value represents the amount of correction needed by the imaging device to correct for the lighting conditions. Thus, a digital camera imaging system via the color transformation 150 may automatically select a first transformation when the image of a scene is captured in the daylight and select a second transformation when the image of a scene is captured under artificial lighting conditions.

In one embodiment, the HVS frequency response model for the perception of spatial variations in luminance and chrominance is based on contrast sensitivity measurements for the human viewer. The luminance spatial frequency response is based on the exponential model:

$${H}_{L} ( \overline{u} ) = {aL}^{b} {ⅇ}^{- \frac{180 \sqrt{{\overline{u}}^{2} + {\overline{v}}^{2}}}{π [ c ln ( L ) + d ]} ,} \qquad ( 6 )$$

where \overline{u}={square root over (\overline{u}²+\overline{v}², u and v are the horizontal and vertical spatial frequency variables in cycles/radian subtended at the retina, L is the average luminance of the light from the print in cd/m², a=131.6, b=0.3188, c=0.525, and d=3.91. L is taken to be 11 cd/m². The model for chrominance is given as:
H_{a,b}(\overline{u})=A^{b}e^{-a{square root over (\overline{u}}^{²}⁺\overline{v}^{²} (7)
where a=0.419 and A=100.

As stated above, the chrominance channel has a narrower bandwidth than the luminance channel. Thus the method 200 can allow more chromatic error than luminance error at lower spatial frequencies without affecting the perception of the image.

Using the spatial frequency response for luminance and chrominance channels, the error \tilde{ε}_{Lab} is computed in the HVS weighted Lab space.

In an alternative embodiment, a fast Fourier Transform (FFT) is used to evaluate the perceptual error in the Fourier domain, to avoid computing the spatial domain convolution of ε_{Lab}[m] and the point spread functions of the Human Visual System (HVS) corresponding to the luminance and chrominance channels. Specifically, the fast Fourier transform (FFT) is used to efficiently compute the discrete Fourier transforms (DFTs) of the luminance and chrominance channels of ε_{Lab}[ml].

Taking the DFT of ε_{Lab}[m] gives:

$${ɛ}_{i}^{k} [ q ] = {\sum }_{m ∈ {R}_{s}} {ɛ}_{i}^{k} [ m ] {ⅇ}^{- j {q}^{T} ( 2 π {S}^{- 1} ) m} \qquad ( 8 )$$

where i=L, a, b, q ε Rₛ, S=diag[S, S]m, and k represents the color patch under consideration. As a measure of the error over the entire patch, the standard 2-norm (∥.∥) is used. Therefore, the mean square error (MSE) per pixel for the kth color patch can be expressed as:

$${Ξ}_{k}^{2} = \frac{1}{{S}^{2}} {\sum }_{q ∈ {R}_{s}} {( {( {w}_{L} {ɛ}_{L}^{k} [ q ] {H}_{L} [ q ] )}^{2} + {( {w}_{a} {ɛ}_{a}^{k} [ q ] {H}_{a} [ q ] )}^{2} + ( {w}_{b} {ɛ}_{b}^{k} [ q ] {H}_{b} [ q ] ) )}^{2} \qquad ( 9 )$$

where H_{L}[q]=H_{L}(S⁻¹q), H_{a,b}[q]=H_{a,b}(S⁻¹q), and w_{L}, wₐ, and w_{b} are weighting factors for adjusting the relative weights between the filtered luminance and chrominance responses. A higher value of w_{L} will force more noise into the chrominance components.

To determine the optimized values, two error metrics are defined. Given the scene illuminant and camera gain setting, these metrics are the average root mean square error (RMSE) φ_{avg} of the color patches and the maximum RMSE error φₘₐₓ among the color patches. The error metrics can be expressed as:

$$\begin{matrix}{ϕ}_{avg} = \frac{1}{M} {\sum }_{1 \leq k \leq M} {Ξ}_{k} , & ( 10 ) \\ {ϕ}_{max} = {max}_{1 \leq k \leq M} {Ξ}_{k} , & ( 11 )\end{matrix}$$

where M is the number of Macbeth patches.

It will be appreciated that more or fewer processes may be incorporated into the method illustrated in FIG. 2 without departing from the scope of the invention and that no particular order is implied by the arrangement of blocks shown and described herein. For example, the method 200 may not compute the color difference in conjunction with block 270. Rather, the method 200 may simply compute the average color difference of the Lab color space.

It further will be appreciated that the methods described in conjunction with FIG. 2 may be embodied in machine-executable instructions, e.g. software. The instructions can be used to cause a general-purpose or special-purpose processor that is programmed with the instructions to perform the operations described. Alternatively, the operations might be performed by specific hardware components that contain hardwired logic for performing the operations, or by any combination of programmed computer components and custom hardware components. The methods may be provided as a computer program product that may include a machine-readable medium having stored thereon instructions which may be used to program a computer (or other electronic devices) to perform the methods. For the purposes of this specification, the terms “machine-readable medium” shall be taken to include any medium that is capable of storing or encoding a sequence of instructions for execution by the machine and that cause the machine to perform any one of the methodologies of the present invention. The term “machine-readable medium” shall accordingly be taken to include, but not be limited to, solid-state memories, optical and magnetic disks, and carrier wave signals. Furthermore, it is common in the art to speak of software, in one form or another (e.g., program, procedure, process, application, module, logic, etc.), as taking an action or causing a result. Such expressions are merely a shorthand way of saying that execution of the software by a computer causes the processor of the computer to perform an action or produce a result.

The generated color transform may be incorporated in numerous types of color imaging systems. FIG. 3 illustrates one embodiment of a digital camera 300 for processing an image of a scene to be stored in a digital format. The digital camera 300 includes a filter 310, an imaging sensor 320, an automatic gain controller (AGC) 325, an analog-to-digital converter (ADC) 330, a processor 340, and a data store 350. The digital camera 300 may also include additional components and circuitry that are well known to those of ordinary skill in the art but that are not shown so as to not obscure the detailed description.

The filter 310 filters visible light to the imaging sensor 320 to capture colorimetric information used to reproduce a digital representation of a scene. The imaging sensor 320 includes a collection of light-sensitive diodes called photosites, which convert light (photons) into electrons (electrical charges). The imaging sensor 320 may include a charge coupled device (CCD), and a complimentary metal oxide semiconductor (CMOS), among other examples of imaging sensors well known to those of ordinary skill in the art. The AGC 325 adjusts the gain in the captured light intensity to compensate for specific lighting conditions. The ADC 330 converts the electrical charges that build up in the imaging sensor 320 into digital signals.

The processor 340 processes the digital signals into the digital image representation of the scene using the image processing application 100 as described above. The processor 340 may be a well-known digital signal processor (DSP). The processor 340 may also direct the digital image onto a local display (e.g. LCD display) coupled to the digital camera 300 or direct the digital image to a remote display via a wired or wireless network connection (not shown).

Data store 350 is a machine-readable storage medium that stores the processed digital image. The data store 350 may be a resident memory device, or a removable storage device, among other examples of digital storage devices.

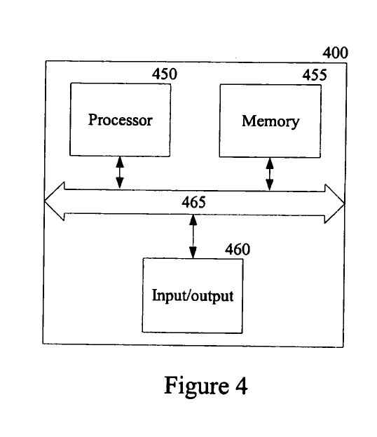

FIG. 4 illustrates a computer system 400 that may be used to design a color transformation component 150 before it is incorporated in an imaging device by simulating the intended imaging processing system. The computer system 400 includes a processor 450, memory 455 and input/output capability 460 coupled to a system bus 465. The memory 455 is configured to store instructions which, when executed by the processor 450, perform the methods described, for example in conjunction with FIG. 2. Input/output 460 may include components to facilitate user interaction with the computer system 400 such as a keyboard, a mouse, a display monitor, a microphone, a speaker, a display, a network card (e.g., Ethernet, Infrared, cable modem, Fax/Modem, etc.), etc. For example, input/output 460 may also provide for the collection of a digital image from, for example, a digital camera. This captured image may be used to design the color transformation component 150 as will be described. Input/output 460 also encompasses various types of machine-readable media, including any type of storage device that is accessible by the processor 450. For example, a machine-readable medium may include read only memory (“ROM”), random access memory (“RAM”), magnetic disk storage media, optical storage media, flash memory devices, electrical, optical, acoustical, or other forms of propagated signals (e.g., carrier waves, infrared signals, digital signals,), etc. Thus, a machine-readable medium includes any mechanism that provides (i.e., stores and/or transmits) information in a form readable by a machine (e.g., a computer). One of skill in the art will immediately recognize that the term “machine-readable medium/media” further encompasses a carrier wave that encodes a data signal.

Thus, a color signal transformation methodology has been described that reduces noise without affecting color fidelity in a color imaging system. Specifically, using the methods described herein, the color transformation minimizes visible noise in an image without affecting the color and brightness in the chrominance channels.

It is understood that the invention is not limited to use in a digital camera. Rather, the color imaging system may include scanners, printers, among other examples well known to those of ordinary skill in the art. Furthermore it is understood that the invention is not limited to a RGB to YCbCr transformation. Rather, one of ordinary skill in the art will recognize that this strategy may be used to design any transformation such as, for example, from a device dependent color space to a device independent and uniform color space.

While the invention has been described in terms of several embodiments, those skilled in the art will recognize that the invention is not limited to the embodiments described. The method and apparatus of the invention can be practiced with modification and alteration within the scope of the appended claims. The description is thus to be regarded as illustrative instead of limiting on the invention.

What is claimed is:

1. A computerized method comprising:
applying simulated noise to image data in a first color space;
transforming the noisy image data into noisy image data in a second color space that has a luminance channel and a chrominance channel; and
generating a color transformation that reduces the noise in the luminance channel.

2. The method of claim 1, wherein the noise is one of demosaic artifact noise, filtering noise, edge enhancement noise, white balance noise, thermal noise, and shot noise.

3. The method of claim 1 further comprising:
acquiring the image data in a first color space from a color patch.

4. The method of claim 1, wherein the first color space is a device dependent color space and the second color space is a device independent color space.

5. The method of claim 1, wherein the first color space is a RGB color space and the second color space is a Lab color space.

6. The method of claim 5 further comprising:
transforming the noisy image data in the RGB color space to noisy YCbCr image data in a YCbCr color space;
transforming the noisy YCbCr image data in the YCbCr color space to noisy XYZ image data in a XYZ color space; and
computing a color difference by subtracting true XYZ image data from the noisy XYZ image data in the XYZ color space.

7. The method of claim 6, wherein image data in the Lab color space is transformed from the XYZ image data in the XYZ color space.

8. The method of claim 7, wherein the image data in the Lab color space is weighted by a spatial frequency response of the luminance and chrominance channels of the human visual system.

9. The method of claim 1 further comprising:
incorporating the generated color transformation into an imaging system.

10. A machine-readable medium having executable instructions to a cause a device to perform a method comprising:
applying simulated noise to image data in a first color space;
transforming the noisy image data into noisy image data in a second color space that has a luminance channel and a chrominance channel; and
generating a color transformation that reduces the noise in the luminance channel.

11. The method of claim 10, wherein the noise is one of demosaic artifact noise, filtering noise, edge enhancement noise, white balance noise, thermal noise, and shot noise.

12. The method of claim 10 further comprising:
acquiring the image data in a first color space from a color patch.

13. The method of claim 10, wherein the first color space is a device dependent color space and the second color space is a device independent color space.

14. The method of claim 10, wherein the first color space is a RGB color space and the second color space is a Lab color space.

15. The method of claim 14, further comprising:
transforming the noisy image data in the RGB color space to noisy YCbCr image data in a YCbCr color space;
transforming the noisy YCbCr image data in the YCbCr color space to noisy XYZ image data in a XYZ color space; and
computing a color difference by subtracting true XYZ image data from the noisy XYZ image data in the XYZ color space.

16. The method of claim 15, wherein image data in the Lab color space is transformed from the XYZ image data in the XYZ color space.

17. The method of claim 16, wherein the image data in the Lab color space is weighted by a spatial frequency response of the luminance and chrominance channels of the human visual system.

18. The method of claim 10 further comprising:
incorporating the generated color transformation into an imaging system.

19. A device comprising:
a processor coupled to a memory through a bus; and
a color transform design process executed by the processor from the memory to cause the processor to apply simulated noise to image data in a first color space, transform the noisy image data into noisy image data in a second color space that has a luminance channel and a chrominance channel, and generate a color transformation that reduces the noise in the luminance channel.

20. The device of claim 19, wherein the noise is one of demosaic artifact noise, filtering noise, edge enhancement noise, white balance noise, thermal noise, and shot noise.

21. The device of claim 19, wherein the color transform design process further causes the processor to acquire the image data in a first color space from a color patch.

22. The device of claim 19, wherein the first color space is a device dependent color space and the second color space is a device independent color space.

23. The device of claim 19, wherein the first color space is a RGB color space and the second color space is a Lab color space.

24. The device of claim 23, wherein the color transform design process further causes the processor to transform the noisy image data in the RGB color space to noisy YCbCr image data in a YCbCr color space, transform the noisy YCbCr image data in the YCbCr color space to noisy XYZ image data in a XYZ color space, and compute a color difference by subtracting true XYZ image data from the noisy XYZ image data in the XYZ color space.

25. The device of claim 24, wherein image data in the Lab color space is transformed from the XYZ image data in the XYZ color space.

26. The device of claim 25, wherein the image data in the Lab color space is weighted by a spatial frequency response of the luminance and chrominance channels of the human visual system.

27. The device of claim 19, wherein the color transform design process further causes the processor to incorporate the generated color transformation into an imaging system.

28. A device comprising:
means for applying simulated noise to image data in a first color space;
means for transforming the noisy image data into noisy image data in a second color space that has a luminance channel and a chrominance channel; and
means for generating a color transformation that reduces the noise in the luminance channel.

29. The device of claim 28, wherein the noise is one of demosaic artifact noise, filtering noise, edge enhancement noise, white balance noise, thermal noise, and shot noise.

30. The device of claim 28, further comprising:
means for acquiring the image data in a first color space from a color patch.

31. The device of claim 28, wherein the first color space is a device dependent color space and the second color space is a device independent color space.

32. The device of claim 28, wherein the first color space is a RGB color space and the second color space is a Lab color space.

33. The device of claim 32 further comprising:
means for transforming the noisy image data in the RGB color space to noisy YCbCr image data in a YCbCr color space;
means for transforming the noisy YCbCr image data in the YCbCr color space to noisy XYZ image data in a XYZ color space; and
means for computing a color difference by subtracting true XYZ image data from the noisy XYZ image data in the XYZ color space.

34. The device of claim 33, wherein image data in the Lab color space is transformed from the XYZ image data in the XYZ color space.

35. The device of claim 34, wherein the image data in the Lab color space is weighted by a spatial frequency response of the luminance and chrominance channels of the human visual system.

36. The device of claim 28 further comprising:
means for incorporating the generated color transformation into an imaging system.
